(19) United States
(12) Patent Application Publication
(10) Pub. No.: US 2005/0247236 A1
(43) Pub. Date: Nov. 10, 2005

(54) Cellulose solution in novel solvent and electrospinning thereof

(76) Inventors: Margaret Wilde Frey, Ithaca, NY (US); Yong Lak Joo, Ithaca, NY (US)

Correspondence Address: BACON & THOMAS, PLLC, 625 SLATERS LANE, FOURTH FLOOR, ALEXANDRIA, VA, 22314, US

(21) Appl. No.: 10/834,041

(22) Filed: Apr. 29, 2004

(51) Int. Cl. D01F 2/02; B29C 47/00

(52) U.S. Cl. 106/311; 264/465

(57) ABSTRACT

Nanoscale diameter cellulose fibers are produced by dissolving cellulose at a level of 3 to 25% (w/w) in a solvent comprising ethylene diamine and salt selected from the group consisting of potassium thiocyanate, potassium iodide and mixtures thereof, the salt present in an amount of 10 to 75% of its saturation point.

### TECHNICAL FIELD

This invention is directed to a solvent composition for dissolving cellulose, to a solution of cellulose in the composition and to electrospinning of cellulose fibers from the solution.

### BACKGROUND OF THE INVENTION

The dissolution of cellulose without chemical modification and/or derivatization has been reported as being an extremely difficult task because cellulose is a stiff molecule characterized by close chain packing.

Currently, only the N-methylmorpholine-N-oxide(NMMO)/H₂O system described in Chanzy, H., et al. J. Polym. Sci: Polym Lett Ed 17, 219-226 (1979) has been used commercially for solvent spinning of cellulose fibers. This system has the disadvantages of requiring high temperature, e.g., greater than 130° C., for dissolution (whereas the temperature at which explosion occurs is about 150° C.), the occurrence of degradation of cellulose and the requirement of an antioxidant to avoid side reactions.

Cuculo, J. A., et al. Patent Publication No. US2003/0136304A1, published Jul. 24, 2003, identifies a combination of ammonia analog and thiocyanate salt for dissolution of cellulose and in paragraph 0043 mentions wet spinning of cellulose. In the working examples 1 and 2 of U.S. 2003/0136304A1, hydrazine and hydrazine hydrate are used as ammonia analog. However, hydrazine is extremely toxic. Working Example 3 of US2003/0136304A1 uses a solvent composition of ethylene diamine and sodium thiocyanate; this solvent composition has been found by the inventors herein to provide a flowing solution of cellulose suitable for electrospinning only when sodium thiocyanate was present in amount of about 50% of saturation even when the percentage of cellulose was 4% (w/w).

### SUMMARY OF THE INVENTION

It has been discovered herein that KSCN provides significant advantages over NaSCN, in combination with ethylene diamine as a solvent for cellulose, in that flowing solutions of cellulose in this solvent were produced at concentrations of 10-75% of saturation in ethylene diamine (concentration is expressed as a % of the KSCN saturation point in ethylene diamine) allowing use of less salt constituent at concentration of cellulose up to about 8% (w/w), i.e., more cellulose than in the case of the NaSCN. Likewise KI provides advantages over NaI in combination with ethylene diamine as a solvent for cellulose.

One embodiment of the invention herein, denoted the first embodiment, is directed to a solvent composition comprising ethylene diamine and a salt selected from the group consisting of potassium thiocyanate, potassium iodide and mixtures thereof, the salt being present in amount of 10 to 75% of saturation in ethylene diamine. This embodiment is useful to produce flowing solutions of cellulose, as well as, solutions of cellulose in gel form. The term “flowing” is used herein to mean the ability to move in a stream at room temperature. The term “gel form” is used to mean does not move in a stream at room temperature.

Another embodiment herein, denoted the second embodiment, is directed to a solution of cellulose, 0.1 to 25% (w/w), in solvent composition comprising ethylene diamine and salt selected from the group consisting of potassium thiocyanate and potassium iodide, the salt being present in amount of 10 to 75% of its saturation point.

Another embodiment herein, denoted the third embodiment, is directed at a method for forming cellulose fibers comprising the steps of dissolving cellulose at a level of 3 to 8% (w/w) in the solvent of the first embodiment to produce a flowing solution and electrospinning cellulose fibers from the solution. In one case, the cellulose has a degree of polymerization greater than 1,000 and the salt is potassium thiocyanate which is present in amount of 50 to 65% of saturation in ethylene diamine, and electrospinning is carried out to provide nanoscale diameter cellulose fibers. The term “nanoscale” is used herein to mean less than 1 micron in diameter.

Another embodiment herein, denoted the fourth embodiment, is directed to a method of forming a mat of a three dimensional network of nanoscale transverse dimension of cellulose fibers, comprising dissolving cellulose of degree of polymerization ranging from 200 to 3,000 in the solvent of the first embodiment at a level of 6 to 25% (w/w) to form a gel comprising self assembled cellulose fibers in a three-dimensional network surrounded by more dilute cellulose solution and removing the solvent to leave a mat of nanoscale transverse dimension cellulose fibers. The term “nanoscale” is used to mean less than one micron.

The terms “a” and “an” as used herein, mean one or more.

The term “about” as used herein is meant to encompass variations of ±2%, e.g., ±0.5% or ±0.1%.

The degree of polymerization (DP) of cellulose is calculated from xanthate seconds (xs) measurements using the equation:
DP=347.7039+315.9949 LOG(xs)+335223(LOG(xs))²
or using a 2-arm size 100 Cannon-Fenske Routine Viscometer and a modified version of ASTM D1795-86 (the modification being that the concentration was varied from specification in order to achieve sufficient flow times where kinematic effects could be ignored, i.e., flow times greater than 100 seconds), unless otherwise stated.

The term “Mᵥ” is used herein to mean viscosity molecular weight and is determined from measurement of intrinsic viscosity. It typically falls between weight average molecular weight and number average molecular weight.

The concentration of cellulose is expressed in terms of weight cellulose per weight of solution (i.e., per weight of cellulose plus ethylene diamine plus salt) and is indicated as w/w, unless otherwise indicated.

### BRIEF DESCRIPTION OF THE DRAWINGS

FIG. 1 is a graph of cellulose (% w/w) versus KSCN (% saturation) using a zero shear mixing method, and depicts results of Working Example I.

FIG. 2 is a graph of cellulose (% w/w) versus KSCN (% saturation) using a gentle shear mixing method and depicts results of Working Example I.

FIG. 3 is a graph of % cellulose per weight of ethylene diamine versus KI (% of saturation in ethylene diarnine) using a gentle shear mixing method and depicts results of Working Example II.

### DETAILED DESCRIPTION

We turn now to the first embodiment of the invention herein, that is a solvent composition comprising ethylene diamine and a salt selected from the group consisting of potassium thiocyanate and potassium iodide and mixtures thereof, the salt being present in an amount ranging from about 10 to 75%, e.g., 25 to 75% or 25 to 65% of its saturation point. Potassium thiocyanate is preferred over potassium iodide. The solvent composition is useful to provide the solutions of cellulose of the second embodiment.

We turn now to the second embodiment of the invention herein, which is directed to a solution of cellulose, 0.1 to 25% (w/w), in the solvent composition of the first embodiment. When the solution is a flowing solution, it is useful for electrospinning production of cellulose fibers, e.g., for purposes of the third embodiment herein, or for wet spinning or dry-jet spinning, e.g., using ethanol as a coagulant, to produce fibers in the 0.5 to 1,000 denier range followed by drawing (annealing) to obtain properties similar to those of Rayon or Lyocell fibers, or to make films via casting or extrusion. When the solution is a gel, it is useful for forming a mat of three dimensional network of nanoscale transverse dimension cellulose fibers, e.g., for purposes of the fourth embodiment herein. With KSCN as salt in the solvent, flowing solutions can be prepared containing, e.g., from 0.1 to 8% (w/w) cellulose. With KI as salt in the solvent, flowing solutions can be prepared containing, e.g., from 0.1 to 8% (w/w) cellulose. With KSCN as salt in the solvent, gels can be prepared containing, e.g., from 8 to 25% (w/w) cellulose. With KI as salt in the solvent, gels can be prepared containing, e.g., from 6 to 10% (w/w) cellulose. The cellulose can be, for example, microcrystalline cellulose, microgranular cellulose, from cotton linters, from cotton batting or from wood cellulose. The degree of polymerization of the cellulose can range, for example, 100 to 3,000 determined as described above. In one case, the degree of polymerization of the cellulose is less than 1,000 and is, for example, mirocrystalline cellulose powder or from cotton linters or can be wood cellulose. In another case, the degree of polymerization of the cellulose ranges from 1,000 to 3,000 and is, for example, cotton batting or wood cellulose. As indicated, wood cellulose falls in both cases and can have a degree of polymerization ranging, for example, from 750 to 3,000. To produce either flowing solutions or gels the salt is usually present in an amount of 25 to 75% of its saturation point, e.g., 25 to 65% if its saturation point, e.g., 30 to 50% of its saturation point. The solutions can be prepared, for example, using a zero shear mixing method (described in Working Example I or a gentle shear mixing method, (e.g., as described in Working Example I or by using a blender on low).

We turn now to the third embodiment herein which is directed to a method for forming cellulose fibers comprising the steps of dissolving cellulose at a level of 3 to 8% (w/w) to produce a flowing solution and electrospinning cellulose fibers from the flowing solution. In one case, the cellulose has a degree of polymerization greater than 1,000, the salt of the solvent is potassium thiocyanate and is present in an amount of 50 to 65% of its saturation point and electrospinning is carried to produce nanoscale transverse dimension (diameter) fibers.

We turn now to the fourth embodiment which is directed at a method form forming a three dimensional network of nanoscale transverse dimension cellulose fibers comprising dissolving cellulose of degree of polymerization ranging from 200 to 3,000 in solvent of the first embodiment at a level of 6 to 25% (w/w) to form a gel comprising self-assembled cellulose fibers in a three dimension network (including clear gels), and removing the solvent to leave a mat of nanoscale dimension cellulose fibers. The solvent is removed, for example, via a non-solvent (solvent for the ethylene diamine and salt but not for cellulose) such as ethanol or methanol, followed by vacuum drying, or by freeze drying or critical point drying using supercooled CO₂, leaving the cellulose structure in uncollapsed form. The solvent should be removed in such a way that the structure does not collapse.

The invention is illustrated in the following Working Examples.

### WORKING EXAMPLE I

Solvent of ethylene diamine and KSCN was used to dissolve cellulose using either a zero shear mixing method or a gentle shear mixing method.

The procedure for the zero shear mixing method in this working example was as follows:

A known amount of dried cellulose was placed inside a centrifugal test tube. 20 mL of ethylene diamine (C₂H₈N₂) was then added to the test tube and mixed for 30 seconds using a Genie Vortex mixer. After the cellulose was well integrated with the liquid, a known amount of salt was added and mixed for an additional minute, inverting the tube once during mixing. If the sample still had clumps of salt, a metal rod was inserted into the tube to try to break up the clumps. When the contents appeared to be well incorporated, the test tube was placed into the freezer (−20° C.) for a minimum of 4 hours. When time had elapsed, the test tube was thawed in a 40° C. water bath for 30 minutes. The thawed sample was mixed for 30 seconds. Dissolution was considered complete when the sample was transparent. Those that did not appear to be clear were returned for another freeze/thaw cycle. The cycle was repeated a maximum of 3 times.

The procedure for the gentle shear mixing method in this working example was as follows:

A known amount of dried cellulose was placed inside a polyethylene Ziplock bag. 20 mL of C₂H₈N₂ was then added to the Ziplock bag and the air removed before sealing. The contents were mixed by hand via a squeezing method to make sure that the cellulose was wetted out. A known amount of salt was added to the Ziplock Bag, the air was removed and then the bag was sealed. A rolling pin was used to crush the salt crystals until the contents were smooth and a thin even layer created. The Ziplock bag was placed into the freezer for 15 minutes. Then, the Ziplock bag was thawed in a 30° C. water bath for 15 minutes. The temperature of the water bath was reduced from 40 to 30° C. because the flash point of C₂H₈N₂ is 38° C.). During that time period, the sample was subjected to shearing motion via the use of the rolling pin. Dissolution was considered complete when the sample was transparent. The transparent sample was then transferred to a centrifugal test tube for easier access to other experiments. Those samples that did not appear to be clear were returned for another freeze/thaw cycle. The cycle was repeated a maximum of 3 times.

In each case, 9 ml (8.028 g) of ethylene diamine was used and amount of KSCN and amount of cellulose were varied. The sample compositions ranged from 2-10% w/w cellulose and 10-75% of its saturation point of KSCN.

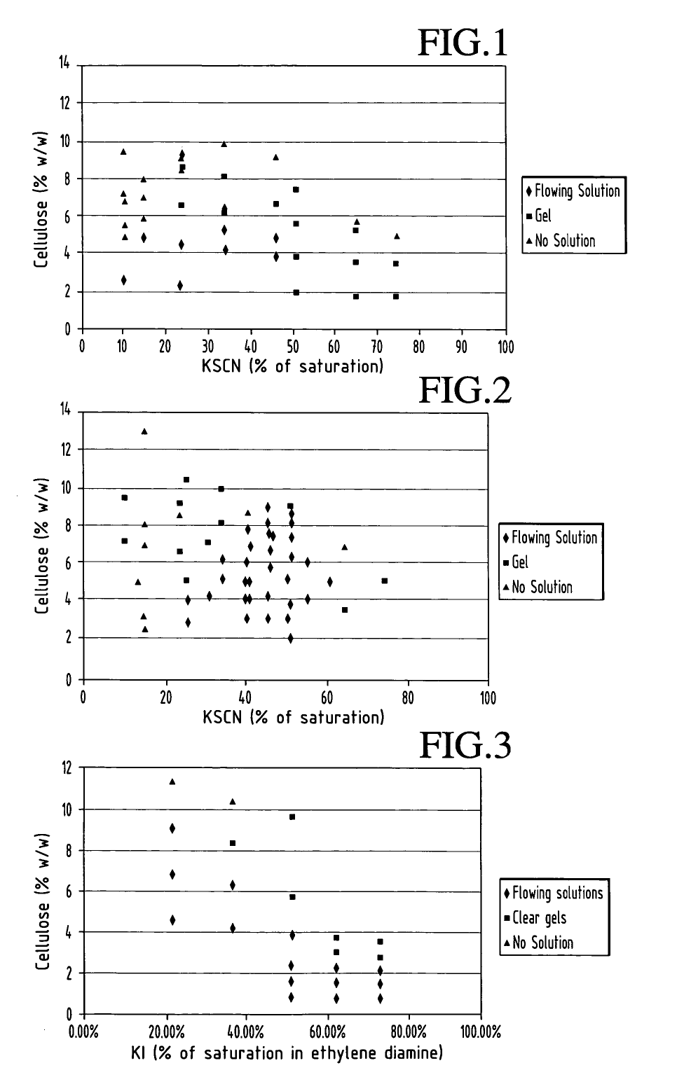

Results for the zero shear mixing tube method with microgranular cellulose powder (CC31), DP of about 210 (literature value) based on usual observation, are shown in FIG. 1.

Results for the gentle shear mixing method with microgranular cellulose powder CC31, based on Theological measurements, are shown in FIG. 2. The Theological measurements were taken using frequency sweeps in a shear rheometer, cone and plate geometry at 25° C. Tan delta values were used to determine which samples were flowing versus gel. Polarized light microscopy was used to confirm that samples did not contain any undissolved cellulose.

A table of gentle shear mixing method results (visual observations), is set forth below:

TABLE 1

| Sample | % w/w | % w/w | Room Temperature |
|---|---|---|---|
| Number | cellulose | KSCN | Appearance |
| 12-4 | 7.31 | 50.78 | flowing solution |
| 13-6 | 9.01 | 50.62 | gel |
| 13-8 | 5.76 | 45.90 | flowing solution |
| 13-9 | 6.63 | 45.95 | gel |
| 13-10 | 7.52 | 45.90 | flowing solution |
| 14-1 | 7.76 | 40.22 | flowing solution |
| 14-2 | 8.64 | 40.24 | gel |
| 14-4 | 8.16 | 50.66 | flowing solution |
| 16-7 | 5.95 | 39.86 | flowing solution |
| 17-6 | 6.30 | 50.80 | flowing solution |
| 18-1 | 5.09 | 49.97 | flowing solution |
| 18-5 | 8.07 | 45.16 | gel |
| 18-6 | 8.93 | 45.24 | flowing solution |
| 18-7 | 5.00 | 40.49 | flowing solution |

### WORKING EXAMPLE II

Solvent of ethylene diamine and KI was used to dissolve cellulose using the gentle shear mixing method.

In each case 9 ml of ethylene diamine was used.

The cellulose used was from cotton linter filter paper (DP of 940, determined using Cannon-Fenske Routine Viscometer as described above).

Results are shown in FIG. 3.

### WORKING EXAMPLE III

Solvent of ethylene diamine and KSCN or KI was used to dissolve cellulose.

In each case, 20 ml of ethylene diamine was used. KSCN in amount of 6 g (40% of saturation), 5.2 g (35 % of saturation) or 4.5 g (30% of saturation) was used. KI in amount of 6.7 g (50% of saturation), 5.4 g (40% of saturation) and 4.0 g (30% of saturation), was used. Cellulose used was TEMBEC PULP HV1OA, a soft wood pulp (DP=2200, Mᵥ=352,000), TEMBEC PULP HV2OA, a soft wood pulp (DP=2300,Mᵥ=372,500, TEMSOL V, a soft wood pulp (DP=790, Mᵥ=127,000) and TEMFILM HWD2, a hard wood pulp ((DP=815, Mᵥ=131,000). DP was determined by the xanthate seconds method described above. Cellulose samples were ground to 20 mesh and dried overnight under vacuum.

Ethylene diamine was measured using a pipette. Cellulose, KSCN and KI were weighed and added. Samples were mixed thoroughly using gentle shear to ensure that all cellulose was wetted out and all salt was dissolved. After mixing, samples were a placed in a freezer at −10° C. for at least 1 hour until frozen solid. Thawed samples were mixed using gentle shear and returned to the freezer. Freeze/thaw cycling was repeated for a total of 3 cycles to insure that dissolution was complete. No change was observed in the samples after the first freeze/thaw cycle.

Results for ethylene diamine/KSCN solvent are set forth in Table 2 below:

TABLE 2

| Materials: | code # | 1 | 2 | 3 | 4 | 5 | 6 | 7 | 8 | 9 | 10 | 11 | 12 |
|---|---|---|---|---|---|---|---|---|---|---|---|---|---|
| cellulose | | 2.1 | 3.1 | 4.2 | 6.3 | 2.2 | 3.2 | 4.3 | 6.5 | 2.2 | 3.3 | 4.5 | 6.7 |
| % (w/w) | | | | | | | | | | | | | |
| Ethylene | | 20 ml | 20 ml | 20 ml | 20 ml | 20 ml | 20 ml | 20 ml | 20 ml | 20 ml | 20 ml | 20 ml | 20 ml |
| Diamine | | | | | | | | | | | | | |
| KSCN (g) | | 6.0 | 6.0 | 6.0 | 6.0 | 5.2 | 5.2 | 5.2 | 5.2 | 4.5 | 4.5 | 4.5 | 4.5 |
| SOLV V | 14- | solution | solution | solution | gel | solution | solution | solution | gel | solution | solution | solution | gel |
| HW 20 | 16- | solution | solution | solution | gel | solution | solution | solution | gel | solution | solution | solution | no sol. |
| HW 10 A | 18- | solution | solution | no sol. | no sol. | gel | gel | no sol. | no sol. | solution | solution | no sol. | no sol. |
| HW 20 A | 20- | solution | gel | gel | no sol. | solution | gel | gel | gel | solution | solution | solution | no sol. |

Results for ethylene diamine/KI solvent are set forth in Table 3 below:

TABLE 3

| Materials: | code # | 1 | 2 | 3 | 4 | 5 | 6 | 7 | 8 | 9 | 10 | 11 | 12 |
|---|---|---|---|---|---|---|---|---|---|---|---|---|---|
| cellulose | | 2.0 | 3.0 | 4.1 | 6.1 | 2.1 | 3.2 | 4.3 | 6.4 | 2.3 | 3.4 | 4.5 | 6.8 |
| % (w/w) | | | | | | | | | | | | | |
| Ethylene | | 20 ml | 20 ml | 20 ml | 20 ml | 20 ml | 20 ml | 20 ml | 20 ml | 20 ml | 20 ml | 20 ml | 20 ml |
| Diamine | | | | | | | | | | | | | |
| KI (g) | | 6.7 | 6.7 | 6.7 | 6.7 | 5.4 | 5.4 | 5.4 | 5.4 | 4.0 | 4.0 | 4.0 | 4.0 |
| SOLV V | 15- | solution | solution | solution | no sol. | solution | solution | no sol. | no sol. | solution | no sol. | no sol. | no sol. |
| HW 20 | 17- | solution | solution | solution | gel | solution | no sol. | no sol. | no sol. | solution | solution | no sol. | no sol. |
| HW 10 A | 19- | solution | no sol. | no sol. | no sol. | no sol. | no sol. | no sol. | no sol. | no sol. | no sol. | no sol. | no sol. |
| HW 20 A | 21- | solution | gel | no sol. | no sol. | gel | no sol. | no sol. | no sol. | no sol. | no sol. | no sol. | no sol. |

### WORKING EXAMPLE IV

Electrospinning experiments were conducted using flowing solutions of cellulose in ethylene diamine/KSCN solvent. A high voltage source was used to apply 30 KV to a 24 gauge needle on a syringe. A syringe pump was used to continually renew the droplet at the syringe tip. #22 and #24 gauge needles were used as spinnerets. Distance between the needle point and the ground was varied from 15 to 20 cm.

Fibers were successfully spun from solutions containing 8% cellulose Type 20 microcrystalline cellulose, DP=140 (determined with Cannon-Fenske Routine Viscometer as described above) and Type CC31 microgranular cellulose powder (DP=210 from literature) with KSCN at 56% of saturation. The fibers were larger than nanoscale diameter. S&S470 cellulose (DP=940, determined with Cannon-Fenske Routine Viscometer as described above) gave similar results.

Cotton fibers from batting (DP=1400, literature value) dissolved at a concentration of 3% w/v in KSCN/ethylene diamine with KSCN concentration at 60% of saturation gave a bead on string morphology; diameters of fiber section measured as small as 500 nm, were obtained. The beads are useful for lubrication applications.

### WORKING EXAMPLE V

Three dimensional, interconnected nanofiber structures were prepared from gels of cellulose in ethylene diamine/KSCN solvent. All ingredients were mixed in a Waring laboratory blender to ensure complete dispersion and mixing of all ingredients. Composition 1: 200 ml ethylene diamine, 67 g KSCN, 24 g Whatman CC-31 cellulose 9% (w/w). Composition 2: 200 ml ethylene diamine, 67 g KSCN, 24 g TEMBEC HV-10A cellulos (9% w/w). Complete dissolution of cellulose was confirmed by polarized light microscopy. Solvent (ethylene diamine/KSCN) was removed from the gels by diffusion into ethanol. The resulting white solid was then vacuum dried at ambient temperature in a Labconco Freeze dry system/freezone 4.5. In each case, the resulting material was a rigid while solid. In each case, the material is comprised of interconnected fibrils less than 100 nm in diameter. Porosity is evident under light microscopy.

Variations

Variations will be obvious to those skilled in the art. Thus, the scope of the invention is determined by the breadth of the claims.

1. Solvent composition comprising ethylene diamine and salt selected from the group consisting of potassium thiocyanate, potassium iodide and mixtures thereof, the salt being present in amount of 10 to 75% of its saturation point.

2. The solvent composition of claim 1 where the salt is potassium thiocyanate which is present in amount of 25 to 75% of its saturation point.

3. Solution of cellulose in the solvent composition of claim 1, wherein the cellulose is present in amount of 3 to 25% (w/w).

4. The solution of claim 3 which flows at room temperature.

5. The solution of claim 3 where the salt is potassium thiocyanate which is present in the solvent in amount of 25 to 65% of its saturation point.

6. The solution of claim 3 where the cellulose has a degree of polymerization less than 1,000.

7. The solution of claim 3 where the cellulose has a degree of polymerization ranging from 1,000 to 3,000.

8. The solution of claim 7 where the cellulose is cotton batting.

9. The solution of claim 3 where the cellulose has a degree of polymerization ranging from 750 to 3,000.

10. The solution of claim 9 where the cellulose is wood cellulose.

11. The solution of claim 3 which is a gel at room temperature containing nanoscale transverse dimension cellulose fibers.

12. A method for forming cellulose fibers comprising the steps of dissolving cellulose in the solvent of claim 1 at a level of 3 to 8% (w/w) to produce a flowing solution and electrospinning cellulose fibers from the flowing solution.

13. The method of claim 11 where the cellulose has a degree of polymerization greater than 1,000 and the salt is potassium thiocyanate which is present in an amount of 50 to 65% of its saturation point and the electrospinning is carried out to produce nanoscale diameter cellulose fibers.

14. A method for forming a three dimensional network of nanoscale transverse dimension cellulose fibers comprising dissolving cellulose of degree of polymerization ranging from 200 to 3,000 in the solvent of claim 1 at a level of 6 to 25% (w/w) to form a gel comprising self-assembled cellulose fibers in a three dimensional network, and removing the solvent to leave a mat of nanoscale dimension cellulose fibers.
